(19) United States
(12) Patent Application Publication
(10) Pub. No.: US 2005/0049025 A1
(43) Pub. Date: Mar. 3, 2005

(54) Blackjack push

(76) Inventor: Geoffrey William Hall, Solihull (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/963,899

(22) Filed: Oct. 13, 2004

Related U.S. Application Data
(63) Continuation-in-part of application No. 10/654,876, filed on Sep. 4, 2003.

(30) Foreign Application Priority Data
Sep. 4, 2002 (GB) 00220501.1

(51) Int. Cl. A63F 13/00

(52) U.S. Cl. 463/12

(57) ABSTRACT

A modification to the card game blackjack in which bets are pushed, if the total of the cards in the player's and the dealer's hands are of equal value and add up to 21 or less, or if the total of the cards in the dealer's hand equals a predetermined value between 22 and 26 and the total of the cards in the player's hand is 21 or less.

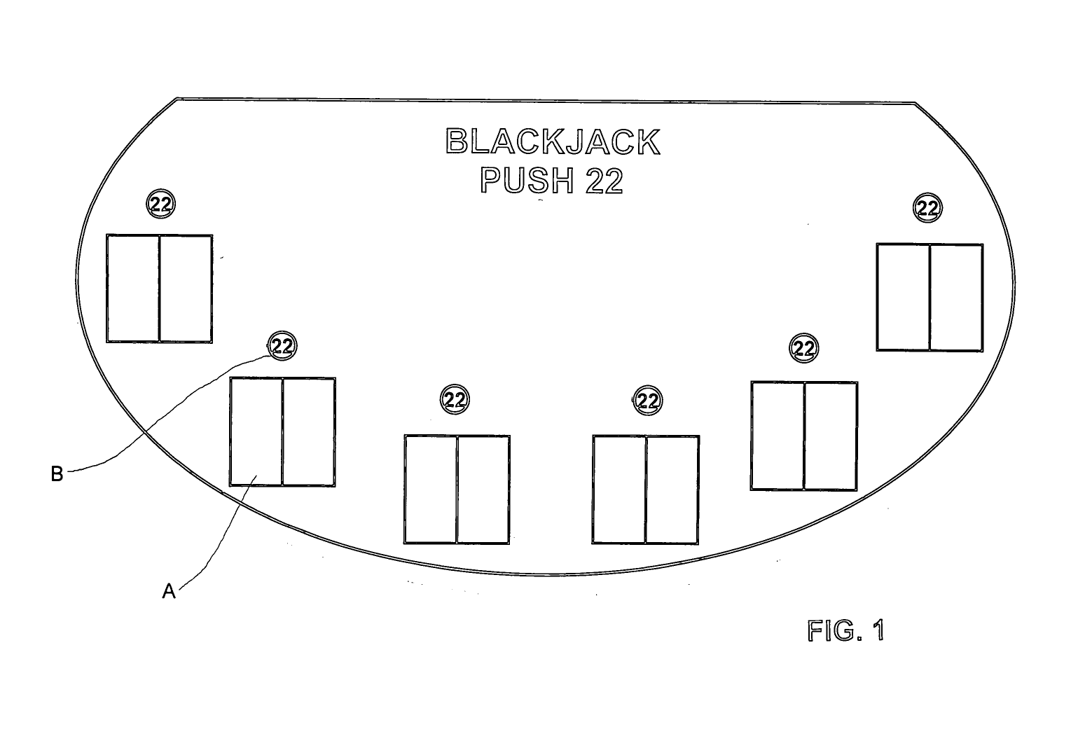

This invention relates to casino house games or, more specifically, the invention relates to the casino game of Blackjack.

Blackjack is a popular casino game and various steps have been taken to try and keep the game interesting and stimulating for the players. This invention is a modification of Blackjack which allows the casino to enjoy an additional edge in the game, by allowing the dealer to “push” i.e. not pay players when the dealer has reached a designated total higher than 21. The game is played with any number of deck of cards.

Normally, in the game of regular Blackjack, any total of 22-26 is considered a “bust” hand so, by choosing 1 or more of these totals to now be a “push”, will create an extra edge for the casino.

To compensate for this extra edge given to the casino, other player-beneficial rules can be added within the game, to allow the casino edge to reduce overall to a similar edge found in regular Blackjack. Examples such as paying higher than normal odds for “Blackjacks”, allowing players to place additional bets after seeing their initial cards and allowing more favorable “doubling” and “splitting” opportunities are a few of the player benefits that could be included.

Additionally, players will be allowed to wager on whether the dealer will arrive at the specified “push” total, or totals. A specially designed layout will include betting areas that allow players the option of placing a further bet (see diagram attached) and the player will win the get if a wager has been placed in the specified betting area and the dealer has made the designated total.

Ideally, the dealer will just “push” on one designated total between 22-26 and the name of the game can reflect which total has been included in the rules. For example, a game called “Blackjack Push 26” will inform the players that the dealer will “push” players' bets on a total of 26. Obviously, the specially designed layout will include betting areas that allow the player to wager on the outcome of the dealer making a total of 26.

A preferred embodiment of the invention will now be described, with reference to the attached diagram.

A specially designed layout is used with additional betting areas having “22” marked on them (see item “B” in diagram), as this particular embodiment allows the dealer to “push” on a total of 22. Each “Blackjack” betting area is divided in half (see item “A” in the diagram) to allow players to place 2 identical “Blackjack” wagers. As the dealer is allowed to “push” on a total of 22, then the players advantageous rule is that after receiving their first 4 cards, that make up the start of each of their 2 Blackjack hands, they can then decide in which order the second cards are placed. In other words, once the players have received their 2 Blackjack hands they then have the option to switch over their 2 top cards (i.e. the second cards from each Blackjack hand). For example, the player is dealt a six and an Ace as his first cards, which make up the initial part of each of his Blackjack hands. Then the player receives a “Jack”, on top of the 6 to make “16” and a “4”, on top of the Ace′ to make “soft” 15. As the Jack and four are the second cards dealt out, then the player may switch these 2 cards over, or, put simply, interchange them. The player will now have one hand consisting of a six and a four and the other hand consisting of and Ace and a Jack.

Once the player has decided whether to “switch”, or not, then both of the player's hands are played out as in regular Blackjack.

Additionally, the player can place a wager in the “22” betting area, before any cards are dealt out. This wager is left until it is the dealer's turn to play his hand. If the dealer makes any total other than 22, then he takes the player's “22” wager. However, if the dealer makes a total of 22 then he will pay the player a predetermined odds, for example 10/1.

The preferably number of player betting boxes, for this particular embodiment, would be 5 although this could be increased or decreased if the casino so desires.

As well as this specific embodiment, the invention could contain one or more of the following:
(i) In the second embodiment, “Blackjacks” would still be paid even if the dealer had reached the designated “push” total.
(ii) In the third embodiment, higher odds could be awarded to the player placing a “push total” bet if the dealer's “push total” was made up of a specific holding. For example, in “Push 22”, the player could be paid much higher odds, for example 25/1, if the dealer were to obtain a total of 22 with four cards of rank, for example 4, 5, 6 & 7, in any order. Again, even higher odds, for example 100/1, could be paid if the 22 was obtained by the four cards of rank specified above were dealt in order or if the four cards of rank specified above were of the same suit.
(iii) In the fourth embodiment, the “push” feature can be included in games of Blackjack where the player is only required to play one hand.
(iv) In the fifth embodiment, the player would be allowed to increase the initial wager, if desired, after seeing either one, or more, of his own cards and also, as extra option, after seeing the dealer's upcard. Any mixture of this could be advocated depending on the casino's edge requirements.
(v) Suited “Blackjacks” could be paid at higher odds than the usual 3/2 payout.
(vi) “Blackjacks” could be paid at even money.
(vii) If players hand comprised three of four cards constituting a specified three/four card poker hand, for example three/four of a kind; a straight; a flush; or a straight flush, the hand would be an automatic winner, irrespective of the total, provided that the total is below 22. Bonus odds may be paid out, depending on the rank of the poker hand, for example 3/1 for three of a kind or a straight flush.
(viii) If a player is dealt a designated wild card, for example card of designated rank e.g. 10, or reaches a designated value, then the bet will be pushed, if the players total subsequently exceeds 21.

This invention could also be used on the Internet, installed on video machines or stored on a disc and played on a computer.

1. A card game based on blackjack, in which:
one or more players place a bet;
the dealer deals at least one card to himself and at least one pair of cards to each of said one or more players;
the dealer then deals one or more further optional cards to each player, until the player stands or the total of the value of the cards in the player's hand exceeds 21;
if the total of the value of cards in the player's hand exceeds 21, the player loses the bet;
the dealer then deals further cards to himself, until he stands, or the total of the value of the cards in his hand exceeds 21;
the dealer then takes the bet of the player, if the total of the value of the cards in the dealer's hand is 21 or less and is greater than the value of the cards in the player's hand;
the dealer pays out on the bet of a player, if the total of the value of the cards in the player's hand is 21 or less and is greater than the total of the value of the cards in the dealer's hand;
all remaining bets on the table are pushed, if the total of the cards in the player's and the dealer's hands are of equal value and 21 or less, or if the total of the value of the cards in the dealer's hand equals a predetermined value between 22 and 26;
the dealer paying out on the player's bet if the total o the value of the cards in his hand exceeds 21 and is not equal to the predetermined value and the total of the value of the cards in the player's hand is 21 or less.

2. A card game according to claim 1 in which the dealer deals two or more pairs to each player.

3. A card game according to clam 1 in which the dealer deals two pairs of cards to each player, the player having the option to switch cards between the two pairs of cards, each pair of cards being subsequently played as a separate hand.

4. A card game according to claim 1 in which the dealer must stand when the total of the value of the cards in his hand is 17 or more.

5. A card game according to claim 1 in which the dealer pays out on blackjacks, even if the total of the value of the cards in the dealer's hand equals the predetermined value between 22 and 26.

6. A card game according to claim 1 in which each player may place an optional bet that the total of the value of the cards in the dealer's hand will equal the predetermined value between 22 and 26.

7. A card game according to claim 6 in which odds paid out on the optional bet may be increased, if the dealer's hand meets specified criteria.

8. A card game according to claim 7 in which the odds paid out on the optional bet are increased when the cards in the dealer's hand are each of specified value and/or the cars in the dealer's hand are suited.

9. A card game according to claim 1 in which a player may increase his initial bet after seeing one or more of the cards dealt to him.

10. A card game according to claim 1 in which blackjacks are paid out at even money.

11. A card game according to claim 10 in which suited blackjacks are paid out at increased odds.

12. A card game according to clam 1 in which the dealer pays out if the players hand is of specified rank, irrespective of the total, provided that the total is less that 22.

13. A card game according to claim 12 in which the dealer pays out if the players hand constitutes a specified three or four card poker hand.

14. A card game according to claim 13 in which the dealer pays out if the players hand is selected from the group containing, three of a kind; four of a kind; a straight; a flush and a straight flush.

15. A card game according to claim 12 in which the odds paid depend on the rank of the players specified hand.

16. A card game according to claim 1 in which is the players hand includes a specified wild card, the bet is pushed if the total of the player hand exceeds 21.

17. A card game according to claim 1 in which is the players hand totals a specified value, then the bet is pushed if the total of the players cards on taking one or more additional cards, then exceeds 21.
